(19) United States
(12) Patent Application Publication
(10) Pub. No.: US 2025/0266254 A1
(43) Pub. Date: Aug. 21, 2025

(54) PLASMA ELEMENT ANALYSIS METHOD AND DEVICE

(71) Applicant: Agilent Technologies, Inc., Santa Clara, CA (US)

(72) Inventors: Tetsuo Nishiyama, Santa Clara, CA (US); Naoki Sugiyama, Santa Clara, CA (US); Mineko Omori, Santa Clara, CA (US); Masahide Fujiwara, Santa Clara, CA (US)

(21) Appl. No.: 18/825,988

(22) Filed: Sep. 5, 2024

(30) Foreign Application Priority Data
Feb. 16, 2024 (JP) 2024-022379

(51) Int. Cl. H01J 49/04; H01J 49/00; H01J 49/10

(52) U.S. Cl. CPC H01J 49/0463; H01J 49/0009; H01J 49/105

(57) ABSTRACT

In order to provide an analysis method and device using laser ablation and a plasma ion source, without requiring a solid standard, embodiments include a plasma element analysis method and device, wherein a solution standard is atomized by a nebulizer and introduced into a plasma, calibration curve data for an element contained in the solution standard is created, a solid sample to be measured is atomized by laser ablation, the solid sample is introduced into the plasma together with an auxiliary liquid from the nebulizer and ionized, element analysis data is created, a concentration of a measured element in the solid sample is acquired from the element analysis data and the calibration curve data, and the concentration of the measured element is corrected and quantified.

### CROSS-REFERENCE TO RELATED APPLICATIONS

This application claims priority to Japanese Patent Application No. 2024022379, filed Feb. 16, 2024, which is incorporated by reference in its entirety.

### TECHNICAL FIELD

The present invention relates to a plasma element analysis method and analysis device for quantifying constituent elements of a solid sample, particularly relates to element analysis using a combination of laser ablation (LA) and a plasma ion source (ICP), and more particularly relates to high frequency inductively coupled plasma mass spectrometry (ICP-MS) or high frequency inductively coupled plasma optical emission spectroscopy (ICP-OES) using laser ablation.

### BACKGROUND

As an analysis method using a plasma ion source, for example, ICP-MS, which is a mass spectrometry, is useful for analyzing inorganic elements, particularly trace metals, and is widely used in many fields including semiconductor, geological, and environmental industries. According to ICP-MS, it is possible to perform multi-element analysis substantially simultaneously on most elements of the periodic table, and it is also possible to quantify the concentration of elements at an excellent sensitivity level of one billionth (ppb) or one trillionth (ppt).

In addition, ICP emission analysis, which is an analysis method using a plasma ion source, is suitable for analyzing a large number of samples having comparatively high element concentrations at high speed, and it is possible to resolve, using a grating, a spectrum specific to an element that has been introduced into a plasma and emitted, and rapidly measure a large number of elements from the emission intensity thereof.

Analysis methods using a plasma ion source are also useful for analyzing a solid sample, and when measuring the solid sample, a solution can be introduced by performing pretreatment such as acid decomposition. However, acid decomposition takes time and is also dangerous, and there is a possibility that the sample will be contaminated with acid. In addition, the entire solid sample is subjected to acid decomposition, and therefore this is not suitable for localized analysis or the like. In contrast to this, when laser ablation (LA) is used as a sample introduction device, a solid sample can be directly introduced, and there is an advantage in also being suitable for localized analysis. From such perspective, LA-ICP-MS and LA-ICP-OES have been used in the earth science field and the like.

For example, patent document 1 teaches art for measuring an element such as carbon or the like, which was conventionally difficult to measure using a LA-ICP-MS device, and correcting measurement results of a measured sample that contains a large amount of that element, thereby quantitatively analyzing the measured element in the measured sample at high precision.

Furthermore, patent document 2 teaches art for performing quantitative analysis without using a solid standard sample, based on ICP signal strength of a solid sample of an LA unit by laser ablation and ICP signal strength of a sample in which a standard liquid sample containing a known amount of elements contained in the solid sample is heated and vaporized by ETV.

### SUMMARY

When sample introduction by LA is used, not only can a solid sample be quickly analyzed in ICP-MS or ICP-OES without pretreating with an acid, but localized analysis and imaging analysis in the solid sample can also be performed. Typically, laser ablation is performed by placing a sample in a cell having a window through which a laser beam can pass and irradiating the sample with the laser while a carrier gas flows. The laser is irradiated focusing on the surface of the sample, and fine particles (aerosol) of the sample generated by the irradiation are introduced into plasma and ionized to be elementally analyzed.

Conventionally, when quantitative analysis of solids is performed using laser ablation, glass standard substances and steel standard substances are used as standard substances. For example, in patent document 1, it is necessary to secure a standard substance that contains at a known concentration an element to be measured having the same composition as the sample to be measured. However, the types and concentrations of elements contained in these standard substances are limited, and such are difficult to use when they do not match the analysis target. Furthermore, when having a different matrix than the analysis target, the element concentration in the sample sometimes cannot be accurately measured because the signal strength is different due to the difference in element ionization efficiency.

Therefore, quantitative analysis is possible for materials such as various iron and steel materials and glass materials having SiO₂ as a main component for which standard samples can be obtained, but when it is difficult to obtain standard samples of materials with close chemical compositions, accurate quantitative analysis is difficult and the scope of application is limited. In patent document 2, quantitative analysis using LA-ICP-MS without using a solid standard sample is proposed, but it is necessary to first identify the elements contained in a solid sample, and then prepare a matrix-matched liquid standard sample whose element concentrations are known.

Therefore, a method and device for performing measurement by an analysis method using laser ablation and a plasma ion source are desired that is capable of quantitative analysis of a solid sample by simple means without requiring a solid standard sample.

### Means for Solving Problem

According to one embodiment of the present invention, a plasma element analysis method for quantifying the constituent elements of a solid sample is provided. In this method, a solution standard is atomized using a nebulizer, for example, and introduced into a plasma, and spectroscopic or mass analysis is performed by excitation and/or ionization, and calibration curve data is created for elements contained in the solution standard. The solid sample to be measured is placed in a cell of a sealed structure, atomized by laser ablation, introduced into the plasma via a gas supplied to the cell together with an auxiliary liquid atomized by, for example, a nebulizer, and subjected to excitation and/or ionization to perform mass analysis, and elemental analysis data is created for elements contained in the solid sample.

In one embodiment, the auxiliary liquid is matrix-matched with the solution standard. Either the preparation of the calibration curve data or the preparation of the elemental analysis data may be performed first. A concentration of a measured element in the solid sample is acquired from the elemental analysis data and calibration curve data, and the concentration of the measured element is corrected to perform quantification.

A measured element that is not included in the solution standard may be included in the solid sample. In one embodiment of the present invention, calibration curve data for this type of measured element may be created based on a semiquantitative coefficient of the measured element and the calibration curve data for the measured element included in the solution standard. The semiquantitative coefficient can be created for all elements by measuring a standard solution containing a plurality of elements of known concentrations, and represents a relative sensitivity of each element. Based on the semiquantitative coefficient obtained in advance and the calibration curve data of a measured sample included in the solution standard, calibration curve data for a measured element not included in the solution standard can be prepared.

According to another embodiment of the present invention, a plasma element analysis device for quantifying the constituent elements of a solid sample is provided. This device includes an analysis unit, for example, a spectroscopic analysis unit or a mass analysis unit, which performs elemental analysis by exciting and/or ionizing by means of plasma a sample introduced from a sample introduction unit. The sample introduction unit may include a cell having a sealed structure in which a solid sample is atomized by laser ablation and introduced into a plasma, and a nebulizer in which a solution standard or auxiliary liquid is individually atomized and introduced into the plasma.

According to a further embodiment of the present invention, the analysis device may implement the analysis method according to the present invention described above. That is, the analysis device can create calibration curve data in the analysis unit for the elements contained in the solution standard that has been atomized by the nebulizer and introduced into the plasma. When the solid sample contains a measured element that is not included in the solution standard, the analysis device may optionally create calibration curve data for this type of measured element based on a semiquantitative coefficient of the measured element and the calibration curve data for the measured element included in the solution standard.

The solid sample is atomized by laser ablation and then joined with the auxiliary liquid atomized by the nebulizer to be introduced into the plasma, and excited and/or ionized to produce elemental analysis data. Either the preparation of the calibration curve data or the preparation of the elemental analysis data may be performed first. The analysis device can further acquire the concentration of the measured element in the solid sample from the element analysis data and the calibration curve data in the analysis unit, and correct the concentration of the measured element to quantify.

The correction of the concentration of the measured element may be performed by normalizing the total concentration of the acquired measured element by an analysis device, and, for example, the normalization is 100% normalization. That is, when the concentration of the measured element acquired from the calibration curve data and the element analysis data is added, the result is normally different from 100 mass %, but by normalizing the total to 100% in this situation, the constituent ratios of the constituent elements of the solid sample can be displayed more appropriately.

However, when the constitution of the main component of the solid sample is known, the analysis unit may be normalized to an amount other than the main component, in which case such may be normalized to, for example, 30%, 50%, or 70%. For example, when the sum of the concentrations of the measured elements is N %, the normalization may be N % normalization. Furthermore, when the measured element is a compound with another element, normalization may be performed by multiplying the concentration of the obtained measured element by a coefficient calculated from a known constitution (chemical formula) of the compound.

The auxiliary liquid may be matrix-matched to the solution standard, and may be, for example, dilute nitric acid of the same concentration of 1 mass % or 3 mass %. As described above, the auxiliary liquid is aerosolized and introduced into the plasma together with the fine particles of the solid sample subjected to laser ablation. That is, fine particles of the solid sample are introduced into the plasma in a wet state, and when an auxiliary liquid is used in the plasma in this manner (wet plasma), the sensitivity of elemental analysis is found to be several times higher.

The auxiliary liquid atomized by the nebulizer may be mixed within the spray chamber with the solid sample atomized by the laser ablation, thereby having an effect in which solid samples having a large particle diameter are lost. Mixing within the spray chamber may be performed at the rear of the spray chamber.

### Effect of Invention

According to the present invention, an analysis method and method are provided that can perform plasma element analysis at high precision of the type and concentration of elements in a solid sample without requiring a solid standard sample or a matrix-matched standard substance. In particular, this is a method and device for analysis using a laser ablation and a plasma ion source, for example, a method and device for LA-ICP-MS or LA-ICP-OES.

### BRIEF DESCRIPTION OF THE DRAWINGS

FIG. 1 is a schematic diagram of an LA-ICP-MS (laser ablation inductively coupled plasma mass spectrometer) according to one exemplary embodiment of the present invention.

FIG. 2 is a schematic diagram of a laser ablation (LA) unit according to one exemplary embodiment of the present invention.

### DETAILED DESCRIPTION

### Quantitative Analysis Device

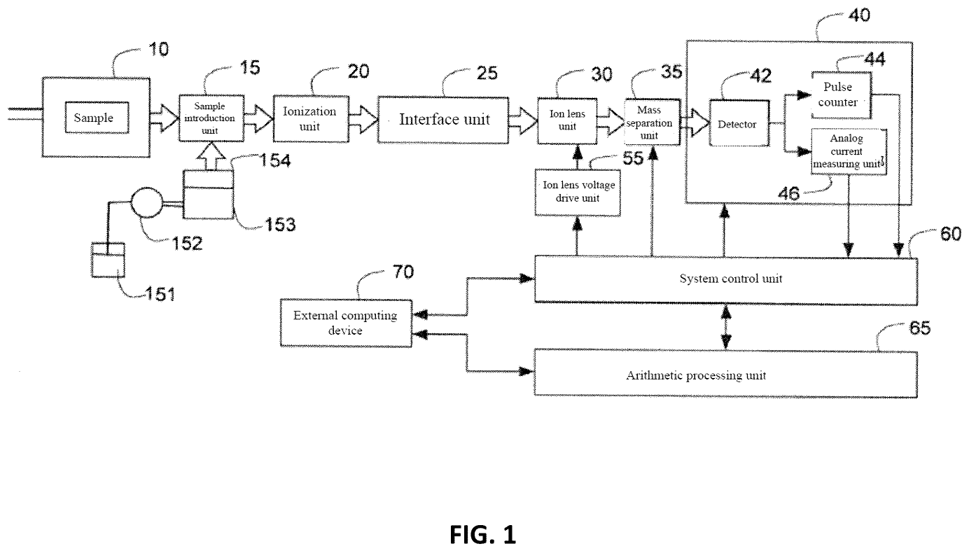

The LA-ICP-MS, illustrated in FIG. 1 which is a quantitative analysis device according to one exemplary embodiment of the present invention, atomizes, that is, aerosolizes, a solid sample to be measured by laser ablation, and then introduces the atomized sample into an inductively coupled plasma (ICP) for excitation and/or ionization. In one embodiment of the present invention, an LA unit 10 that performs laser ablation on a solid sample disposed in a cell chamber and a liquid introduction unit 12 that includes a nebulizer are connected to a sample introduction unit 15. The LA unit has a sealed structure, and a carrier gas is introduced into the chamber as described later and is connected to an ionization unit 20 of the ICP-MS device, more specifically an ICP-MS device.

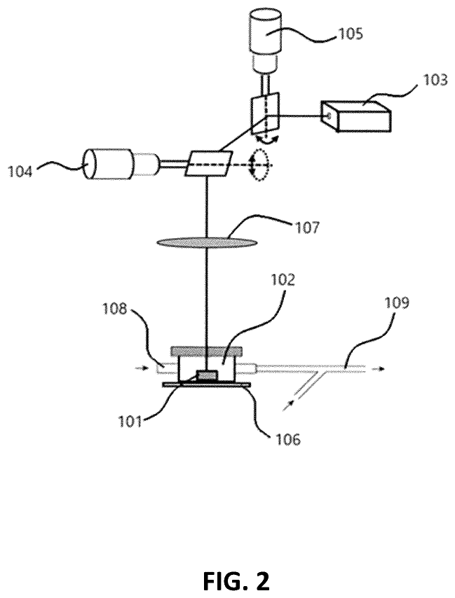

As illustrated in FIG. 2, the LA unit 10 has a sample cell 102 in which a solid sample 101 to be analyzed is disposed in a chamber, and a laser irradiation mechanism is provided that is mainly provided with a laser oscillator 103 and galvanometer mirrors 104 and 105 in the X-axis direction and the Y-axis direction. The sample cell 102 is installed on a stage 106, and the stage 106 can horizontally extract the sample surface by correcting and inclination three-dimensionally by, for example, a two-axis gonioscopic mechanism (not illustrated). After setting the sample cell 102 on the stage 106, the positioning of ablation can be performed while observing the sample surface using, for example, a coaxial camera (not illustrated) having an AF function. Such setting may be performed from, for example, a dedicated tablet terminal.

In this type of LA unit 10, a laser light emitted at a predetermined wavelength from the laser oscillator 103 is reflected by the galvanometer mirrors 104 and 105 in the X-axis direction and the Y-axis direction, passes through an fθ lens 107 for condensing, and irradiates the surface of the solid sample 101 to be analyzed. As the laser for ablation, for example, a Nd:YAG laser of 213 nm or 266 nm, an excimer laser of 193 nm, or the like may be used, but preferably, a laser having a femtosecond (fs) pulse width is used. By using the short wavelength laser, the sample aerosol can be reduced, ionization within the plasma can be promoted, elemental separation can be suppressed, and matrix effect increase and spike-like signals due to lowering of the plasma temperature can also be suppressed.

By using an extremely short pulse laser such as a femtosecond laser, a sample having high thermal conductivity can be analyzed without heating or melting. In particular, for thermally conductive substances having a low melting point, such as a metal, alloy, or the like, particles more accurately reflecting the element composition of a bulk substance can be obtained.

An introduction pipe 108 for introducing carrier gas consisting of rare gas such as helium and argon, and a lead-out pipe 109 for leading out the carrier gas to the outside of the sample cell 102 are connected to the sample cell 102. The lead-out pipe 109 is connected to the ionization unit 20 of the ICP-MS device at the sample introduction unit 15. Accordingly, the carrier gas introduced into the sample cell 102 by the introduction pipe 108 is guided to the ionization unit 20 through the lead-out pipe 109 together with the solid sample 101 vaporized by irradiation of the laser light.

In one specific embodiment, a deep ultraviolet laser (FHG: fourth harmonic) of an ultrashort pulse (femtosecond) emitted from the laser oscillator 103 is reflected by the galvanometer mirrors 104 and 105 in the X-axis direction and the Y-axis direction and condensed by the fθ lens 107, and ablation of the solid sample 101 is performed. The solid sample 101 is instantaneously heated and vaporized by ablation, and then re-conglomerated (re-coalesces) to become fine particles. The fine particles (aerosol) thus generated have a size of several hundred nanometers, and are carried from the lead-out pipe 109 to a sample introduction unit 15 by carrier gas of helium or argon supplied from an introduction pipe 108 to a sample cell 102. Note that argon may be mixed in here to increase the transport efficiency to the ionization unit 20 (see the arrow in FIG. 2).

In an exemplary embodiment of the present invention, a vial 151 for introducing a liquid sample is connected to the sample introduction unit 15 via a pump 152 and a nebulizer 153. The nebulizer 153 converts the liquid sample into aerosol and may include a spray chamber 154 for removing large droplets from the aerosolized sample. The sample supply lead-out pipe extending from the nebulizer 153 may be guided to the ionization unit 20 by joining with a lead-out pipe 109 extending from the sample cell 102 of the LA unit 10 at the sample introduction unit 15. The fine atomized sample sprayed in the spray chamber 154 is sorted by particle size in the chamber, and a portion thereof is guided to the plasma of the ionization unit 20. The remainder may be discharged from the drain.

The nebulizer 153 may utilize argon and other inert gases from a gas source to aerosolize the liquid sample. The inert gas may be the same as the gas used for forming the plasma in the ionization unit 20. The pump 152 may be a peristaltic pump or a syringe pump. The vial 151 may include an auxiliary liquid such as a solution standard or a nitric acid aqueous solution according to an embodiment of the present invention, but may also include various other tuning liquids, calibration liquids, rinsing liquids, and the like. Furthermore, an automatic device configured to switch various vials may also be included.

Fine particles or an aerosol generated from the solid sample 101 by laser ablation, a solution standard or auxiliary liquid aerosol sucked by the pump 152 from the vial 151 and atomized by the nebulizer 153, and/or both of these are introduced into the ionization unit 20 from the sample introduction unit 15, decomposed in the plasma, atomized, ionized, and then analyzed by a mass spectrometer.

As another configuration, the fine particles or the aerosol from the LA unit 10 may be introduced into the spray chamber 154 and mixed with the aerosol introduced from the nebulizer 153. That is, joining of the sample supply lead-out pipe extending from the nebulizer 153 and the lead-out pipe 109 extending from the sample cell 102 of the LA unit 10 in the sample introduction unit 15 may be performed in the spray chamber 154. In particular, the configuration may be such that both are mixed at a rear portion of the spray chamber 154. These configurations have an advantage in that it is possible to discharge particles having large particle diameters from the drain, from among the microparticles introduced from the LA unit 10.

A solid and/or liquid sample is introduced into an ionization unit 20 from a sample introduction unit 15 through aerosolization by laser ablation or a nebulizer, and elements contained in the sample are decomposed and ionized by high temperature plasma generated by high frequency electromagnetic induction in the ionization unit 20. The ionization unit 20 is normally provided with a plasma torch for generating plasma and an interface unit 25 constituting a differential exhaust system including a sampling cone and a skimmer cone is positioned near a tip of the plasma torch. Ions generated by the ionization unit 20 are sampled by the interface unit 25 and converged by an ion lens unit 30 to form an ion beam, after which only ions of a selected mass-to-charge ratio (m/z) are allowed to pass, and therefore are typically incident on a mass separation unit 35 configured from a quadrupole mass filter.

The mass separation unit 35 is configured such that polarities of two opposing rod electrodes from among four parallel rod electrodes configuring the quadrupole mass filter are the same (the polarities of one opposing two rod electrodes and the polarities of the other opposing two rod electrodes are opposite), and by applying a voltage where a predetermined direct current voltage and a predetermined high-frequency alternating current voltage are superimposed, only ions having a specific mass-to-charge ratio are allowed to pass and reach the detector 42. Mass resolution can be adjusted by changing a ratio between the direct current voltage and the high-frequency alternating current voltage applied to the rod electrodes. These settings of the mass charge ratio and the mass resolution may be set by a system control unit 60 in response to a desired input setting of an operator via, for example, an external computing device 70 of the mass spectrometer.

Next, the ion beam is introduced into a high vacuum chamber having a detector 42 therein. The detector 42 is typically configured from a secondary electron multiplier and outputs an electric signal corresponding to the number of ions arriving per unit time at a predetermined mass-to-charge ratio, separated by the mass separation unit 35. An electric signal output from the secondary electron multiplier is sent to a pulse counter 44 and an analog current measuring unit 46, and a pulse count value according to a pulse frequency of the electric signal and an analog current value of the electric signal are respectively measured by the pulse counter 44 and the analog current measuring unit 46. The detector 42, the pulse counter 44, and the analog current measuring unit 46 constitute an ion measuring unit 40.

The ion lens in the ion lens unit 30 is configured so that a voltage is applied from an ion lens voltage drive unit 55. The ion lens is configured from an electric field type lens group having an effect of changing the orbit of ions by using an electric field, and is configured so that the ion transmittance is changed according to the voltage applied to the electrode. Therefore, the ion transmittance of the ion lens can be increased or decreased by controlling the ion lens voltage drive unit 55 via the system control unit 60 and appropriately changing the voltage applied to the electrode of the ion lens. During normal measurement, the voltage applied to the ion lens is set to a predetermined voltage such that the transmittance of ions of an isotope of an analyzed element for which ion strength is to be measured is maximized.

The system control unit 60 controls the operation of each block in FIG. 1, and the arithmetic processing unit 65 performs data processing such as converting the measured analog current value into an ion count per second (cps) for each mass-to-charge ratio (m/z). The mass spectrometer and the external computing device 70, such as a PC (personal computer), are connected via a network or the like, and data such as ion strength measurement values (ion count) is transferred to the computing device 70, and thus it is possible to carry out a calculation process for obtaining the ion strength of ions of isotopes of the analyzed to be measured and an input/output process with the user.

Note that when the analysis is optical emission spectroscopy such as ICP-OES, as is well known, the elements excited and/or ionized by the plasma are emitted as a spectrum, decomposed into a line spectrum by the diffraction grating and guided to the detector, and the emission intensity is counted by, for example, a photomultiplier pipe.

### Quantitative Analysis Method

According to one embodiment of the present invention using a quantitative analysis device such as described above, a solution standard is atomized and introduced into a plasma, and calibration curve data is prepared for at least one arbitrary element included in the solution standard. The calibration curve data may be created for a portion or all of the elements included in the solution standard. Furthermore, calibration curves may be prepared for each element using at least one concentration of the standard solution. Creation of the calibration curve data may be performed by, for example, an arithmetic processing unit 65 and/or the computing device 70. Furthermore, as described above, when there is an element to be measured in a solid sample that is not included in the solution standard, the calibration curve data may be prepared using a semiquantitative coefficient.

A standard solution having a large number of mixed elements may be used as the solution standard. Various types of these standard solutions are commercially available, and nitric acid, hydrochloric acid, sulfuric acid, and the like are used as the matrix. For example, a standard solution containing various elements at concentrations having certified values is commercially available from SPEX, Inc. of the United States, and a standard solution containing 35 elements such as XSTC-622 may be used, for example. The concentration may be suitably diluted when producing a calibration curve, and one or more types of solution standards may be used.

In this respect, with reference to FIG. 1, the standard solution is diluted with ultrapure water having a specific resistance of, for example, 18.0 MΩ or more, put into the vial 151 at several different element concentrations, introduced into the plasma of the ionization unit 20 from the nebulizer 153 via the sample introduction unit 145 by a wetted pump 152, mass spectrometry is performed by the ICP-MS, and a calibration curve is created based on the relationship between each concentration and the signal intensity. In analytical applications that use a solid sample as is, such as LA-ICP-MS, it is preferable to create a calibration curve for as many elements as possible because all elements in the sample that include the matrix element are measured in most cases. Accordingly, a mixture of appropriate combinations of standard solutions to encompass all elements in the sample may be used as the solution standard.

An internal standard method may be used in the present invention. When the internal standard method is used, an internal standard element is added at a predetermined concentration with respect to the solution standard at the time of preparation of the calibration curve and added at a predetermined concentration with respect to the auxiliary liquid introduced from the nebulizer at the time of sample measurement. There is an advantage in that a plurality of internal standard elements can be added instead of one, thereby correcting for matrix effects that affects mass bias. The correction by the internal standard element may be performed when quantifying the measured element.

Next, the solid sample to be measured is atomized by laser ablation, optionally introduced into the plasma together with the auxiliary liquid, and ionized to prepare elemental analysis data. When atomizing by laser ablation, as illustrated in FIG. 2, the solid sample 101 to be analyzed is disposed in the sample cell 102 mounted on the stage 106 having an appropriate size. After performing positioning such as horizontal alignment by a coaxial camera that is not illustrated, a laser is irradiated from a laser irradiator 103 via a galvanometer mirror to atomize the solid sample 101. The irradiation may be performed in an appropriate pattern according to the application, such as a line shape, a raster shape, or a single point shape.

The atomized solid sample 101 is introduced from the sample cell 102 to the ionization unit 20 of the ICP-MS via the sample introduction unit 15 by a carrier gas such as helium. At this time, the auxiliary liquid may be simultaneously introduced from the vial 151 by the nebulizer 153. The same matrix as the solution standard matrix can be used as the auxiliary liquid. In one non-limiting example, the auxiliary liquid is dilute nitric acid in a concentration of 1 to 5 mass %. The detection sensitivity of the ICP-MS can be increased more than when the auxiliary liquid is not used by introducing the laser-ablated fine particle aerosol into the ionization unit 20 together with the auxiliary liquid.

At this time, as described above, the configuration may be such that the fine particles or the aerosol from the LA unit 10 is/are introduced into the spray chamber 154 and the aerosol introduced from the nebulizer 153 is mixed within of the spray chamber 154, particularly at the rear portion of the spray chamber 154. Thereby, it becomes possible to discharge particles having large particle diameters from the drain, from among the fine particles introduced from the LA unit 10.

The signal strength of the elements of the solid sample 101 analyzed in this manner is converted to an ion count per second (cps) for each mass charge ratio (m/z) by, for example, the arithmetic processing unit 65, and elemental analysis data is obtained. The concentration (content) of the element in the solid sample 101 to be analyzed is acquired from the element analysis data and the calibration curve data created above. This can be performed by, for example, reading the concentration corresponding to the signal strength of an element in the solid sample to be analyzed indicated by the element analysis data from the calibration curve data in the arithmetic processing unit 65 and/or the external computing device 70.

In the present invention, a standard addition method may also be used. In this case, when preparing calibration curve data for an element contained in the solution standard by atomizing the solution standard and introducing into plasma, the solid sample to be measured may be atomized by laser ablation and introduced into the plasma together with the solution standard. The concentration of each element can be calculated from a signal intensity difference between the obtained calibration curve data and the elemental analysis data obtained by laser ablating the solid sample to be measured and introducing the solid sample into the plasma together with the auxiliary liquid. The concentration of each obtained element is normalized to 100%, and the correct concentration can be found.

Furthermore, according to one embodiment of the present invention, the concentration of the measured element acquired in this manner is corrected and normalized. In the LA-ICP-MS, measurement of all the elements of the solid sample 101 is possible, and by using calibration curve data prepared for many elements as described above, content data can be acquired for substantially all component elements that constitute the solid sample 101. In this manner, in the present invention, substantially all of the component elements of the solid sample are measured, and thus the total concentration of all of the elements measured can be corrected to, for example, 100%, whereby it becomes possible to correct variations in the amount of ablation. That is, the amount of laser ablation from the solid sample 101 may vary depending on the material (for example, a steel sample and a resin sample) and the surface state (for example, a flat sample and an uneven sample), but in the present invention, by correcting to a value relative to the total value of all concentrations of the measured elements, any difference in the ablation efficiency can be automatically corrected, and analysis can be simplified.

According to one embodiment of the present invention, the types of elements contained in a solution standard used in the preparation of calibration curve data include at least 70% of the component elements that make up a solid sample, preferably at least 80%, more preferably at least 90%, still preferably at least 95%, and most preferably 100%. The calibration curve data is created for as many constituent elements as possible in the solid sample, and thus elements in the solid sample can be accurately quantified after the normalization.

Furthermore, according to one embodiment of the present invention, for a sample for which the configuration of the main component is known, for example, a sample for which a predetermined main component element is 30% or 50%, these main component elements may not be measured, and the total measured element concentration may be normalized and corrected to 70% or 50%. Examples of such cases include cases where the main component element is a compound with an element that cannot be measured by the ICP-MS, such as a fluoride (CaF and the like), a nitride (GaN and the like), or an oxide (CaO and the like), cases where an alloy in which the ratio of Al, Co, Ni, and the like is known cannot be measured for all of the principal components, and cases where the concentration of some of the principal components is known, for example, in cases where the mass % of C is known by another analysis method in the analysis of plastics. Note that in any of the cases of CaF, GaN, CaO, correction of the 100% normalization may be performed after Ca and Ga are measured and compound correction is performed based on a known constitution (chemical formula).

When a profile of the solid sample in the depth direction is taken, once laser scanning (scanning) is performed in a layered shape continuing within the same range, accurate analysis of each layer cannot be performed due to the influence of edges formed on the solid sample by ablation. According to one embodiment of the present invention, the scanning range may be narrowed as the depth increases. That is, the sample introduction unit controls the laser optical system so as to narrow the scanning range after each instance of a set number of laser beam scans, for example, during laser ablation, and the influence of the scanning range edge on the quantitative analysis in the depth direction of the solid sample can be eliminated.

Furthermore, as another control mode, the sample introduction unit controls the laser optical system so as to narrow the scanning range after each instance of a set number of laser beam scans, for example, during laser ablation, and the analysis unit can extract and analyze only the data of the scanning range at a common position in the depth direction of the solid sample.

Moreover, as another control mode, the sample introduction unit controls the laser optical system so as to change the focal height of the laser on the solid sample after each instance of a set number of laser beam scans, for example, during laser ablation, and analysis in the depth direction can always be performed with the same beam diameter.

Software for enabling analysis and correction may also be used in the present invention. An example of such software is MassHunter from Agilent Technologies.

### EXAMPLES

In the following example, the LA-ICP-MS is configured as illustrated in FIG. 1. A Laser Blender Raijin α, which is a laser ablation device from Seishin Trading Co., Ltd. is used as the laser ablation (LA) unit 10. The solid sample 101, being up to 50 mm×25 mm, may be disposed in the sample cell 102 on the stage 106 of the LA unit 10. A window through which a laser beam can pass is provided on the upper part of the sample cell 102, and a fourth harmonic (¼ wavelength) femtosecond laser can be irradiated through a galvanometer mirror to the surface of the solid sample. The sample cell is provided with a connection opening for the introduction pipe 108 to which He is supplied as a carrier gas and the lead-out pipe 109 connected to the sample introduction unit 15.

The inductively coupled plasma mass spectrometer (ICP-MS) used was an Agilent 8900 Triple Quadrupole ICP-MS manufactured by Agilent Technologies. In the sample introduction unit 15, a triplet joint is connected to a resin pipe extending from the nebulizer and is connected to the lead-out pipe 109 from the LA unit 10.

First, calibration curve data was prepared using that to which was added a necessary element standard for XSTC-622 (1% nitric acid) made by SPEX Inc. in the United States as a solution standard. Y, Rh, and Ti were added as internal standard elements. Three different metal solid certification standard substances, CRM-191-2 (dynamo steel), BAM-310 (98.5% Al), and ERM-EB385 (pure copper), were used as solid samples to be analyzed. Furthermore, the same internal standard element was added as an auxiliary liquid that was introduced into the plasma together with the fine particle aerosol that was laser ablated, and a solid sample that was laser ablated was mass analyzed using wet plasma using 1% dilute nitric acid that was matrix-matched to the solution standard. From the obtained elemental analysis data and calibration curve data, the content data of the elements in the solid sample was acquired, and the total of all element nodes was corrected to 100%. The results are shown in Table 1.

TABLE 1
Aqueous standard external calibration curve method quantitative results (units: ppm)

| | CRM191-2 dynamo steel | | | BAM 310 Al | | | ERM-EB385 Cu | | |
|---|---|---|---|---|---|---|---|---|---|
| | Certified | Quantitative | Consistency | Certified | Quantitative | Consistency | Certified | Quantitative | Consistency |
| Element | value | value | rate (%) | value | value | rate (%) | value | value | rate (%) |
| Li | | | | 3.66 | 3.47 | 95 | | | |
| Be | | | | 1.28 | 1.2 [symbol] | 101 | | | |
| Mg | | | | 9940 | 93 [symbol] | 94 | 2 [symbol] | 3 [symbol] | 10 [symbol] |
| Al | 9851 | 9729 | [symbol] | Main | 988000 | | 2 [symbol] | 32 [symbol] | 11 [symbol] |
| | | | | component | | | | | |
| Si | 326 [symbol] | 31716 | 97 | 79 [symbol] | [symbol] | 10 [symbol] | | | |
| [symbol] | [symbol] 7 | 99 | 114 | | | | 1 [symbol] | 14.2 | 110 |
| Ca | | | | 7.3 | 7.0 | 9 [symbol] | | | |
| Ti | 24 | 25 | 105 | 30.1 | 3 [symbol] .9 | 103 | 3.83 | 4.06 | 10 [symbol] |
| V | | | | 44.4 | 4 [symbol] .4 | 104 | | | |
| C [symbol] | 314 | 297 | 94 | 9 | 10.2 | 113 | 9.81 | 10.49 | 1 [symbol] 7 |
| M [symbol] | 1 [symbol] | 1236 | 9 [symbol] | [symbol] | 34.8 | 113 | 10.1 | 10.5 | 104 |
| Fe | Main | 9 [symbol] | | | | | 45.4 | 44 [symbol] | 99 |
| | component | | | | | | | | |
| | (95%) | | | | | | | | |
| C [symbol] | | | | | | | [symbol] | 7.13 | 103 |
| Ni | 224 | 220 | 98 | 24.4 | [symbol] | 10 [symbol] | 11.9 | 12 [symbol] | 10 [symbol] |
| Cu | 165 | 152 | 92 | | | | Main | 999000 | |
| | | | | | | | component | | |
| Zn | | | | | | | | | |
| G [symbol] | | | | 115.2 | 118.2 | 10 [symbol] | | | |
| [symbol] | 18 | 20 | 100 | | | | 11.4 | 12.0 | 106 |
| S [symbol] | | | | | | | 7.2 | 7.9 | 110 |
| Zr | | | | 13 [symbol] | 1 [symbol] | 101 | | | |
| Me | 20 | 15 | 92 | | | | | | |
| Ag | | | | | | | 2 [symbol] .6 | 29.4 | 103 |
| Cd | | | | 23 [symbol] | 23.2 | 98 | 5.8 | 6. [symbol] | 106 |
| Sn | [symbol] | 49 | 98 | 23 [symbol] | 23.9 | 101 | 1 [symbol] | 18.4 | 102 |
| Sb | | | | | | | 19.1 | 21. [symbol] | 113 |
| Te | | | | | | | 10 | 11.8 | 118 |
| P [symbol] | | | | 3 [symbol] | 31 [symbol] | 91 | 11.3 | 1 [symbol] | 111 |
| [symbol] | | | | | | | [symbol] .81 | 5 [symbol] | 97 |

[symbol]

indicates data missing or illegible when filed

### INDUSTRIAL APPLICABILITY

The analysis method and device of the present invention are useful in applications where elemental analysis of various solid surfaces, for example, solid surfaces of pure metals and alloys, is to be performed at high precision without using solid standard substances.

### DESCRIPTION OF REFERENCE NUMERALS

10 Laser ablation (LA) unit
15 Sample introduction unit
20 Ionization unit
101 Solid sample
102 Sample cell
103 Laser oscillator
104,105 Galvanometer mirror
106 Stage
153 Nebulizer
154 Spray chamber

1.-24. (canceled)

25. A plasma element analysis method for quantitating constituent elements of a solid sample without using a solid standard, comprising:
atomizing, with a nebulizer, a solution standard for introduction into plasma, exciting and ionizing fine particles of the solution standard for spectroscopic analysis or mass spectrometry to prepare calibration data for elements contained in the solution standard;
pulverizing a solid sample placed in a cell of a closed structure by laser ablation, supplying gas to the cell for introducing the ablated particles into plasma together with an auxiliary liquid atomized with the nebulizer for spectroscopic analysis or mass spectrometry to prepare element analysis data for elements contained in the solid sample;
obtaining, from the element analysis data and the calibration data, concentrations of measured elements of the solid sample; and
correcting the concentrations of the measured elements for quantification by standardizing a total of the obtained concentrations of the measured elements to 100%,
wherein the solution standard and the auxiliary liquid each contain one or more internal standard elements for performing a correction based on the internal standard elements at the time of quantification of the measured elements.

26. The analysis method according to claim 25, wherein calibration data is prepared for a measured element of the solid sample not contained in the solution standard on the basis of a semiquantitative coefficient of the measured element and calibration data of the measured elements contained in the solution standard.

27. The analysis method according to claim 25, wherein the atomized solution standard is introduced into plasma together with laser-ablated fine particles of the solid sample for preparing the calibration data.

28. The analysis method according to claim 25, wherein the atomized auxiliary liquid is mixed with the solid sample pulverized by laser ablation in a spray chamber or a rear portion of the spray chamber.

29. The analysis method according to claim 25, wherein the laser is a femtosecond laser.

30. The analysis method according to claim 25, wherein the plasma element analysis is ICP-OES or ICP-MS.

31. A plasma element analysis method for quantitating constituent elements of a solid sample without using a solid standard, comprising:
atomizing, with a nebulizer, a solution standard for introduction into plasma, exciting and ionizing fine particles of the solution standard for spectroscopic analysis or mass spectrometry to prepare calibration data for elements contained in the solution standard;
pulverizing a solid sample placed in a cell of a closed structure by laser ablation, supplying gas to the cell for introducing the ablated particles into plasma together with an auxiliary liquid atomized with the nebulizer for spectroscopic analysis or mass spectrometry to prepare element analysis data for elements contained in the solid sample;
obtaining, from the element analysis data and the calibration data, concentrations of measured elements of the solid sample; and
correcting the concentrations of the measured elements for quantification by standardizing a total of the obtained concentrations of the measured elements to 100%,
wherein the measured element is a compound with another element and the standardization is performed by multiplying the concentration of the measured element by a coefficient calculated from a known configuration of the compound.

32. The analysis method according to claim 31, wherein calibration data is prepared for a measured element of the solid sample not contained in the solution standard on the basis of a semiquantitative coefficient of the measured element and calibration data of the measured elements contained in the solution standard.

33. The analysis method according to claim 31, wherein the atomized solution standard is introduced into plasma together with laser-ablated fine particles of the solid sample for preparing the calibration data.

34. The analysis method according to claim 31, wherein the atomized auxiliary liquid is mixed with the solid sample pulverized by laser ablation in a spray chamber or a rear portion of the spray chamber.

35. The analysis method according to claim 31, wherein the laser is a femtosecond laser.

36. The analysis method according to claim 31, wherein the plasma element analysis is ICP-OES or ICP-MS.

37. A plasma element analysis apparatus for quantifying constituent elements of a solid sample without using a solid standard, comprising:
a spectroscopic analyzer or a mass spectrometer for exciting and ionizing a sample introduced from a sample introducer for elemental analysis,
wherein the sample introducer comprises a cell of a closed structure for pulverizing a solid sample by laser ablation to introduce ablated particles into plasma together with a carrier gas, and a nebulizer for separately atomizing a solution standard and an auxiliary liquid for introduction into the plasma,
wherein the spectroscopic analyzer or the mass spectrometer is operable to:
prepare calibration data for elements contained in the solution standard atomized with the nebulizer and introduced into the plasma, excited and ionized;
prepare element analysis data by exciting and ionizing elements contained in the solid sample pulverized by laser ablation and introduced into the plasma together with the auxiliary liquid atomized with the nebulizer;
obtain, from the element analysis data and the calibration data, concentrations of measured elements of the solid sample; and
correct the concentrations of the measured elements for quantification by standardizing a total of the obtained concentrations of the measured elements to 100%,
wherein the solution standard and the auxiliary liquid each contain one or more internal standard elements and the spectroscopic analyzer or the mass spectrometer is operable to perform a correction based on the internal standard elements upon quantification of the measured elements.

38. The analysis apparatus according to claim 37, wherein the spectroscopic analyzer or the mass spectrometer is operable to:
prepare calibration data for a measured element of the solid sample not contained in the solution standard on the basis of a semi-quantitative coefficient of the measured element and the calibration data of the measured elements contained in the solution standard.

39. The analysis apparatus according to claim 37, wherein the nebulizer includes a spray chamber and the sample introducer mixes the solid sample pulverized by laser ablation with the auxiliary liquid atomized with the nebulizer in the spray chamber or a rear part of the spray chamber.

40. The analysis apparatus according to claim 37, wherein the spectroscopic analyzer or the mass spectrometer is operable to introduce the atomized solution standard into plasma together with laser-ablated fine particles of the solid sample for preparing the calibration data.

41. The analysis apparatus according to claim 37, wherein the sample introducer performs the laser ablation within a scan area that narrows when a set laser beam scan number is reached for eliminating influences of scan area edges on quantitative analysis of the sample in a depth direction.

42. The analysis apparatus according to claim 37, wherein the sample introducer performs the laser ablation within a scan area that narrows when a set laser beam scan number is reached and the spectroscopic analyzer or the mass spectrometer is operable to extract data from a common scan area in the depth direction of the sample.

43. The analysis apparatus according to claim 37, wherein the sample introducer performs the laser ablation while changing a focus height of the laser when a set laser beam scan number is reached for performing analysis in a depth direction at the same beam diameter.

44. The analysis apparatus according to claim 37, wherein the plasma element analysis is ICP-OES or ICP-MS.

45. A plasma element analysis apparatus for quantifying constituent elements of a solid sample without using a solid standard, comprising:
a spectroscopic analyzer or a mass spectrometer for exciting and ionizing a sample introduced from a sample introducer for elemental analysis,
wherein the sample introducer comprises a cell of a closed structure for pulverizing a solid sample by laser ablation to introduce ablated particles into plasma together with a carrier gas, and a nebulizer for separately atomizing a solution standard and an auxiliary liquid for introduction into the plasma,
wherein the spectroscopic analyzer or the mass spectrometer is operable to:
prepare calibration data for elements contained in the solution standard atomized with the nebulizer and introduced into the plasma, excited and ionized;
prepare element analysis data by exciting and ionizing elements contained in the solid sample pulverized by laser ablation and introduced into the plasma together with the auxiliary liquid atomized with the nebulizer;
obtain, from the element analysis data and the calibration data, concentrations of measured elements of the solid sample; and
correct the concentrations of the measured elements for quantification by standardizing a total of the obtained concentrations of the measured elements to 100%,
wherein the measured element is a compound with another element and the standardization is performed by multiplying the concentration of the measured element by a coefficient calculated from a known configuration of the compound.

46. The analysis apparatus according to claim 45, wherein the spectroscopic analyzer or the mass spectrometer is operable to:
prepare calibration data for a measured element of the solid sample not contained in the solution standard on the basis of a semi-quantitative coefficient of the measured element and the calibration data of the measured elements contained in the solution standard.

47. The analysis apparatus according to claim 45, wherein the nebulizer includes a spray chamber and the sample introducer mixes the solid sample pulverized by laser ablation with the auxiliary liquid atomized with the nebulizer in the spray chamber or a rear part of the spray chamber.

48. The analysis apparatus according to claim 45, wherein the spectroscopic analyzer or the mass spectrometer is operable to introduce the atomized solution standard into plasma together with laser-ablated fine particles of the solid sample for preparing the calibration data.

49. The analysis apparatus according to claim 45, wherein the sample introducer performs the laser ablation within a scan area that narrows when a set laser beam scan number is reached for eliminating influences of scan area edges on quantitative analysis of the sample in a depth direction.

50. The analysis apparatus according to claim 45, wherein the sample introducer performs the laser ablation within a scan area that narrows when a set laser beam scan number is reached and the spectroscopic analyzer or the mass spectrometer is operable to extract data from a common scan area in the depth direction of the sample.

51. The analysis apparatus according to claim 45, wherein the sample introducer performs the laser ablation while changing a focus height of the laser when a set laser beam scan number is reached for performing analysis in a depth direction at the same beam diameter.

52. The analysis apparatus according to claim 45, wherein the plasma element analysis is ICP-OES or ICP-MS.
